(19) United States
(12) Patent Application Publication
(10) Pub. No.: US 2006/0036047 A1
(43) Pub. Date: Feb. 16, 2006

(54) Device and method of producing low molecular polymers

(76) Inventors: Peter Klostermann, Bad Lauterberg (DE); Johannes Sandmann, Wuppertal (DE); Hans-Ulrich Moritz, Bendestorf (DE); Joerg Horn, Gondenbrett (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/202,546

(22) Filed: Aug. 12, 2005

Related U.S. Application Data
(60) Provisional application No. 60/601,428, filed on Aug. 12, 2004.

(51) Int. Cl. C08F 2/00; B01J 19/00

(52) U.S. Cl. 526/64; 526/319; 422/131; 422/132

(57) ABSTRACT

The invention relates to a loop reactor for carrying out continuous polymerization reactions for the production of polymers with adjustable polymer properties comprising a three-dimensional tubular loop comprising at least two tube bends with interposed tube segments, the tube bends having a curving angle of greater than 30°, and the distance between two tube bends being at least three times the tube diameter, the tube bends and the tube segments being arranged in a direction reversed to the curving direction of the tube bends arranging in succession.

### CROSS REFERENCE TO RELATED APPLICATION

This application claims the benefit of U.S. Provisional Application No. 60/601,428, filed Aug. 12, 2004, which is hereby incorporated by references in its entirely.

### FIELD OF THE INVENTION

The invention relates to a reactor for carrying out continuous polymerization reactions and to a process for the continuous production of poly(meth) acrylates in this reactor.

### DESCRIPTION OF RELATED ART

A number of procedures are known for producing acrylic polymers. Achievement of the desired molecular weight and molecular weight distribution is influenced by the method of process control under discontinuous, semi-continuous and/or continuous mode of operation, by the reaction conditions and the selection of the material system. Solvent, type and concentration of initiator and regulator can therefore be selected purposefully for adjustment of a desired molecular weight and distribution. The costs and risks are drawbacks when using solvents in these processes, especially if solvent-free acryl polymers are desired. Therefore, solvent-free mass polymerization methods are increasingly being developed.

Bulk polymerization is possible only to a limited extent in continuous stirred-tank reactors owing to the relatively high degree of heat liberation during rapid polymerization reactions, for example, by direct cooling via the educt feed. During an absence or interruption in educt feed, there is a risk of an uncontrolled run-through. It is therefore preferable to use reactors with a larger specific heat exchange area, such as tubular, Taylor or loop reactors, for the continuous mode of operation, loop reactors predominantly being used to achieve a narrow molecular weight distribution. Static mixer units are usually used for achieving adequate transverse mixing in loop reactors, to guarantee reliable discharge of the reaction heat, products of uniform quality and avoidance of reactor fouling, see DE-A 196 38 094, DE-A 42 36 058, EP-A 650 985, EP-A 752 268 and WO 01/05843. Apart from the high investment costs, the drawback of static mixers resides in the difficulty in cleaning the reactor. A pronounced drop in pressure also occurs at the static mixer units, so a high input of energy is required to convey the reaction mass in the reactor.

According to DE-A 196 34 450, a tubular reactor having alternating helical tube turns is used. If the flow rate in this reactor is to be increased, this necessitates an increase in the tube length in order to obtain the same average residence time with the same tube diameter.

EP-A 471 500 discloses a method employing a tube reactor with sets of cooling loops inside the reactor, which, at the same time, act as static mixer units.

WO 01/05842 discloses a tube reactor with a number of curved connections, consisting of a large number of tube segments, for producing three-phase suspensions.

### SUMMARY OF THE INVENTION

The invention relates to a loop reactor for carrying out continuous polymerization reactions for the production of polymers with adjustable polymer properties comprising a three-dimensional tubular loop comprising at least two tube bends with interposed tube segments, the tube bends having a curving angle of greater than 30°, and the distance between two tube bends being at least three times the tube diameter, the tube bends and the tube segments being arranged in a direction reversed to the curving direction of the tube bends arranging in succession.

In particular, the reactor according to the invention enables the production of polymers with a narrow molecular weight distribution, with a defined average molecular weight and with a high monomer conversion. The reactor has a very good discharge of heat, has a simple construction and provides good intermixing of the materials.

The invention also relates to a process for continuous production of polymers, particularly of (meth)acrylate copolymers, having the aforementioned polymer properties, using the reactor.

### BRIEF DESCRIPTION OF DRAWINGS

FIG. 1 compares the conditions in a reactor with tube bends to a simple state of the art loop reactor.

FIG. 2 shows a variant of an embodiment of the reactor according to the invention.

### DETAILED DESCRIPTION OF THE INVENTION

The loop reactor according to the invention ensures a very good discharge of heat as well as allows thorough transverse mixing without the addition of any additional static mixer units.

Surprisingly, the reactor according to the invention makes possible a flow of the reaction mixture which leads to an unexpected high mass and heat transport, also in the direction vertically to the main flow direction, even with Reynolds-Number of lower than 2,300. This is contrary to the situation in unloaded linear tube reactors wherein the flow can be laminar, turbulent or in a range between this, depending on the Reynolds-Number. The production of low molecular polymers having an average molecular weight Mn of, e.g., 1000 to 6000 g/mol and a narrow molecular weight distribution of Mw/Mn (dispersion index) of 1.5 to 4 may be achieved. Mw and Mn are determined by gelpermeation chromatography using polystyrene as calibration substance, according to DIN 55672-1.

The tube bands of the reactor preferably have a curving angle of greater than 60°, particularly greater than 90°.

The number of tube bends can be in the range of 2 to several hundred, for example, up to 300 and is limited by technical and costs extent. Preferably, the number of tube bends amounts to 10 to 50, especially preferred are 20 to 30.

The distance between two tube bends is at least 3 times and at most 150 times the tube diameter, preferably 5 to 100 times, particularly preferably 10 to 30 times the tube diameter.

Tube segments, which have an angle of at most 30° extend between these tube bends. Preferably the tube segments have a straight configuration that means without curvature. The number of tube segments is determined by the number of tube bends.

The cross section of the tube bends and the tube segments is substantially circular, but may also have an ellipsoidal or an angular configuration.

Direction reversed to the curving direction of the tube bends, arranged in succession, means that each of the next tube segment, located between two tube bends, showing a direction largely in opposition to the direction of the previous tube segment.

Direction reversed to the curving direction of the tube bends, arranged in succession, means also that each of a next number of at least two tube bends, including, if necessary, interposed tube segments, showing, in their formation, a direction largely in opposition to the direction of the previous number of tube bends.

The dimension of the reactor according to the invention is determined by the proportion of the tube length to the number of tube bends, multiplied with the tube diameter. The proportion of the tube length to the number of tube bends, multiplied with the tube diameter, is from 3.25 to 600, preferably from 3.5 to 220, particularly preferably from 3.75 to 60. The tube length is the total length of all tube elements of the loop reactor, that means the sum of the tube segments and the tube bends. In case of curved tube elements the length of the tube centre line is considered. The tube centre line is that line having an equal distance to the tube walls in case of tubes with a circular cross section.

In case of ellipsoidal configuration of the cross section, the diameter of the tube bends and the tube sections is the mean value of the biggest and the smallest axis of the ellipsoidal diameter.

In case of angular configuration of the cross section, the diameter of the tube bends and the tube sections is the so-called hydrodynamic diameter. The hydrodynamic diameter is a diameter, which would result for a tube with a circular diameter with the same area as of the angular cross section.

The return flow ratio of the reactor according to the invention is determined by the ratio of the returned reaction mixture, which is returned into the reactor, to the reaction mixture discharged from the reactor. The ratio of return flow is, e.g., in the range of 0 to 200, preferably 1 to 20. The reaction mixture consists of monomers, additional agents and the reaction product.

The residence time and therefore the reaction time of the reaction mixture are controlled by adjusting the flow rate of the reaction mixture through the reactor. The flow rate is the mass stream in the reactor comprising of the reaction mixture of the monomers, additional agents and the reaction product. The reaction time between the reactants is shortened at a high flow rate and vice versa.

A residence time of the reaction mixture in the reactor of at least 3 minutes is ensured by setting a specific flow rate. At the same time the selected flow rate ensures that a specific constant amount of reaction mixture remains in the reactor zone. The reaction product formed is continuously removed from the reaction mixture at the same flow rate at which the monomer mixture is supplied.

The polymerization temperature may vary, for example in a range of room temperature to 300° C., e.g., 120 to 280° C., depending on the monomer composition and the initiator used. The ratio of desired properties with respect to molecular weight, dispersion index and conversion into the reaction product is most favourable within this temperature range.

Pressures of up to 100 bar may be applied. In principle, it is also possible to work under normal atmosphere, for example, by employing an open processing system.

Additional pressure to the reactor system may also be applied, for example by using gases as auxiliaries, e.g., supercritical carbon dioxide.

According to the invention, it is advantageous to operate the reactor according to the invention in such a way that a continuous mode of operation is permitted by continuous supply of the reaction mixture comprising monomers and further ingredients and continuous discharge of the reaction mixture comprising the polymer product, and in that the reactor can also be operated not only when partially filled but also when completely filled, i.e. flooded, with a return flow ratio of 5 to 15.

The resulted polymer product is received by simple discharging from the reactor system by separating of monomer residue, e.g., with a vacuum evaporator, and returning it to the reactor system, if necessary.

The reactor according to the invention may comprise additional devices, for example, feed devices for additional materials and devices, such as solvents, mixer units, measuring points, sampling, heating, cooling.

It is also possible to use more than one loop reactor according to the invention to carry out continuous polymerization reactions, for example by arranging at least two loop reactors of this type in succession, and the geometry and dimensions of the reactors may be identical to or different from one another. In addition, the loop reactor according to the invention may also be combined by being preceded or followed by further conventional reactors, for example, conventional loop reactors, tubular reactors, stirred reactors, preferably by being followed thereby.

The sole use of the reactor according to the invention or the combination of the reactor according to the invention with a conventional reactor, tubular reactor or loop reactor is preferred.

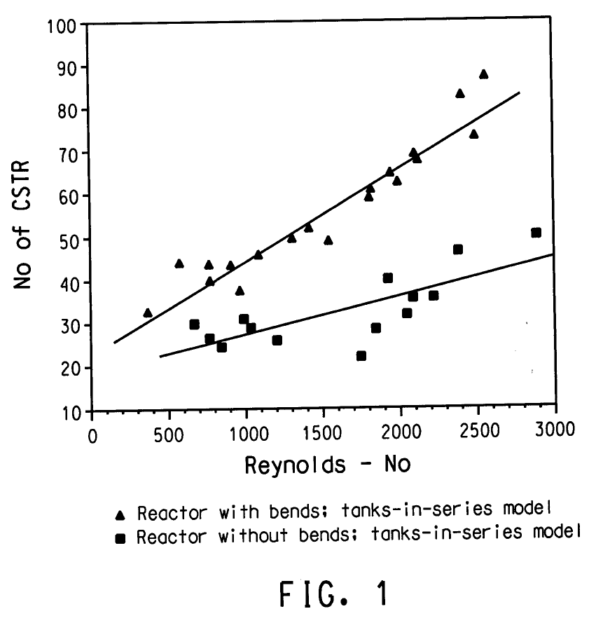

The mixing effect achieved with the reactor according to the invention may be expressed by the conditions during simulation by means of the stirred reactor model of Levenspiel (Octave Levenspiel, “Chemical Reaction Engineering”, 3rd Edition, J. Wiley & Sons, New York, (1999), Chapter 14: “The Tanks-In-Series Model”, pages 321-338), see FIG. 1.

The course of the triangles in FIG. 1 determines the conditions in a reactor with tube bends according to the invention. The course of the rectangles determines the conditions in a simple loop reactor of state of the art.

The reactor according to the invention may be used, in particular, to carry out continuous polymerization reactions. These may all be radical, ionic and thermal polymerization reactions, including polycondensation and polyaddition, suspension and emulsion reactions under the conventional temperature and pressure conditions. Polymerizable ethylenically unsaturated monomers may be used, for example, mono and diolefins, ethylenically unsaturated mono or dicarboxylic acids, monoethylenically unsaturated sulphonic acids, the salts thereof, vinyl aromatic compounds, vinyl alkyl ethers, vinyl alkyl esters, vinyl halides and mixtures thereof.

Examples of suitable monomers include ethylene, propylene, butadiene, acrylic acid, methacrylic acid, maleic acid, fumaric acid, itaconic acid, esters of acrylic acid or methacrylic acid with methanol, ethanol, n-propanol, acrylamide, acrylonitrile, styrene, vinyl ethyl ether, N-vinyl pyrrolidine, vinyl chloride, vinyl pyridine, optionally with further additives such as crosslinking agents and additives as well as initiators. The monomers may be supplied together or separately, for example in the form of an emulsion, with the other additives.

In particular, the reactor according to the invention may be used for the continuous production of (meth)acrylate copolymers.

The term (meth)acrylic denotes acrylic and/or methacrylic.

The (meth)acrylate copolymers are produced preferably by radical polymerization by continuous introduction, preferably of all of the monomer mixture and further ingredients into the reactor according to the invention.

The polymerization reaction preferably takes place without solvent.

With a residence time of, e.g., 3 to 20 minutes, by adjusting the flow rate, the molecular weight of the (meth)acrylate copolymer may be reduced in a temperature range according to the invention of e.g., 160 to 200° C. The molecular weight of the copolymer according to the invention may also be reduced by raising the reaction temperature within the temperature range according to the invention, with a given residence time.

The polymerization reaction is preferably initiated with small amounts of radical initiators. For complete conversion of the monomer mixture to the desired (meth)acrylate copolymer and without simultaneous production of undesirable secondary reactions and therefore for a rapid, efficient and economical polymerization process, it is advantageous to minimize the use of polymerization reactors.

When using initiators, the type and amount thereof are selected in such a way that they are completely consumed at the end of the reaction. The initiators may be added to the monomer mixture, added after a time delay or added separately, for example, in an amount of 0 to 10% by weight based on the weighed monomer.

Examples of radical initiators include dialkyl peroxides, diacylperoxides, hydroperoxides, peresters, peroxide dicarbonates, perketals, ketone peroxides, azo compounds, CC-cleaving initiators, multiple-funktionalised initiators and combinations thereof.

It is particularly preferable to work in the absence of an initiator.

Small amounts of conventional chain-transfer agents, for example, mercaptans, thioglycolesters, chlorinated hydrocarbons, cumene, may be used to control the molecular weight.

Preferably, the use of these chain-transfer agents is avoided.

The polymerization conditions according to the invention, such as reaction temperature, reaction time of the monomer mixture and flow rate, allow the formation of (meth)acrylate copolymers according to the invention with an average molecular weight Mn between 1000 and 6000 g/mol, in particular between 1500 and 4000 g/mol, particularly preferably, between 1500 and 3000 g/mol, with a monomer conversion of 90 to 95% and a dispersion index of between 1, 5 and 4, preferably lower than 2 (Mn determined by gel permeation chromatography, polystyrene gel crosslinked with divinylbenzene as the stationary phase, tetrahydrofuran as the liquid phase, polystyrene standards).

The (meth)acrylate copolymers according to the invention preferably lie in a calculated glass transition temperature range between −5 and +80° C., preferably between 0 and +75° C.

Examples of monomers which are suitable for the production of (meth)acrylate copolymers include esters of (meth)acrylic acid, functionalised and non-functionalised, their conversion products and further copolymerizable unsaturated monomers.

Examples of functionalised monomers include monomers with hydroxy functions, such as hydroxyalkyl esters of unsaturated carboxylic acids, such as (meth)acrylic acid, for example hydroxyethyl (meth)acrylate, butane diol monoacrylate, reaction products of hydroxyethyl (meth)acrylate with caprolactone, epoxy functionalised monomers such as glycidyl (meth)acrylate, adducts of glycidyl (meth)acrylate, and saturated short-chained fatty acids, adducts of glycidylesters of markedly branched monocarboxylic acids, for example Cardura® E (glycidylester of versatic acid) with unsaturated COOH functional compounds, such as (meth)acrylic acid, maleic acid, crotonic acid, adducts of Cardura® E with unsaturated anhydrides, such as maleic acid anhydride, reaction products of glycidyl (meth)acrylate with saturated branched or unbranched fatty acids, for example butanoic acid, capronic acid, palmitic acid.

Examples of non-functionalized (meth)acrylic monomers include long-chained branched or unbranched alkyl (meth)acrylates, such as ethyl hexyl (meth)acrylate, decyl (meth)acrylate, hexadecyl (meth)acrylate, tert.-butyl cyclohexyl (meth)acrylate.

Examples of short- and medium-chained alkyl (meth)acrylates include methyl (meth)acrylate, butyl (meth)acrylate, pentyl (meth)acrylate, dodecyl (meth)acrylate, octadecenyl (meth)acrylate.

Glycidyl(meth)acrylate, methyl (meth)acrylate and isobornyl (meth)acrylate are preferred monomers.

Examples of further unsaturated further monomers include monovinyl aromatic compounds, for example styrene, vinyl toluene, chlorostyrene, methyl styrene, vinyl phenol, vinyl esters of ∝,∝-dialkyl-substituted branched aliphatic monocarboxylic acids and alkyl esters of maleic acid, fumaric acid, tetrahydrophthalic acid, crotonic acid, vinyl acetic acid. Styrene and its derivatives, such as vinyl toluene, are preferably used.

Further monomers, such as multiply unsaturated monomers, may also optionally be used. Examples of multiply unsaturated monomers include monomers comprising at least two polymerizable olefinically unsaturated double bonds, such as hexanediol di(meth)acrylate, ethylene glycol di(meth)acrylate, trimethylol propane tri(meth)acrylate. Monomers of this type are advantageously contained in the monomer mixture in a proportion of less than 5% by weight, based on the total weight of monomers.

For example, a monomer mixture of glycidyl (meth)acrylate, non-functionalized and functionalized (meth)acrylates and unsaturated further monomers is preferably used. The proportions may vary, for example, in the following ranges:
3 to 60% by weight glycidyl (meth)acrylate,
0 to 80% by weight non-functionalized (meth)acrylates,
0 to 40% by weight functionalized (meth)acrylates, and
0 to 80% by weight unsaturated further monomers,
   wherein the sum of monomers adds up to 100% by weight in each case.

Preferably acid functional monomers are excluded as functionalized (meth)acrylates.

Preferably a monomer mixture is used consisting of
3 to 60% by weight glycidyl (meth)acrylate,
0 to 80% by weight non-functionalized (meth)acrylates, and
0 to 80% by weight unsaturated further monomers.

For example, a monomer composition comprising 30 to 35% by weight styrene, 20 to 50% by weight glycidyl (meth)acrylate and 20 to 45% by weight methyl (meth)acrylate may be used.

A low-molecular (meth)acrylate copolymer having a narrow molar mass distribution is obtained by the method according to the invention. Almost complete conversion of the monomers into the polymer product is achieved by the process control with the reactor according to the invention in the absence substantially of chain-transfer agents and radical initiators and in the absence of solvent. Minimal amounts of unreacted monomers may be recycled into the reaction process during or after completion of the reaction. Reaction conditions, such as high reaction temperature and flow rate, also contribute to high monomer conversion and lead to the low-molecular ungelled (meth)acrylate copolymer according to the invention.

In addition, a low-molecular (meth)acrylate copolymer with an invariably uniform product make-up may be achieved, in particular, by using the continuously operating reactor according to the invention.

The (meth)acrylate copolymers produced according to the invention may be used, for example, individually or in a mixture with further binders and optionally, crosslinking agents as binders in paint compositions, in particular as binders in powder paint compositions.

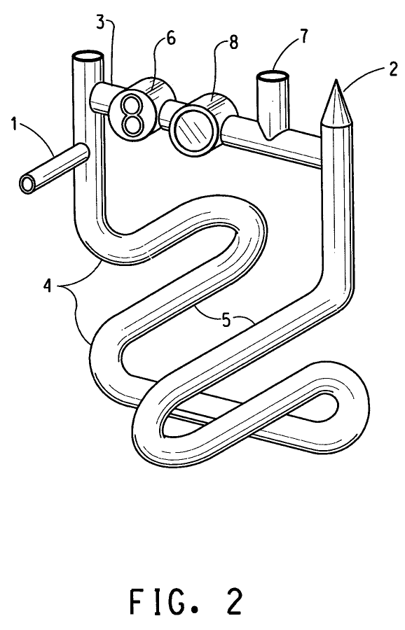

FIG. 2 shows a variant of an embodiment of the reactor according to the invention.

The reactor consists of an inlet (1) and an outlet (2) with an interposed tube segment (3) and a loop, which is characterized by the arrangement of a plurality of tube bends (4) and interposed straight tube segments (5)—starting from the inlet and ending in the direction of the outlet. The number of tube bends (4) is 6, the number of interposed straight tube segments (5) is 6. The distance between two tube bends is 30 times the diameter of the circular tube.

The tube segment (3) contains a pump (6) and measuring devices for temperature and pressure (7) and for spectroscopy (8).

The following example describes exemplarily the continuous mode of operation according to the invention with the reactor according to the invention.

### EXAMPLE

The used monomer mixtures of the experiments 1 to 5 are described in Table 1 comprising the parts per weight of methyl methacrylate (MMA), glycidyl methacrylate (GMA), styrene and initiator. Di-tertiary butyl peroxide resp. tertiary butylperoxi-2-ethyl-peroxi hexanoate (TBPEH) und di-tertiary amylperoxide (Tx 201 of Akzo Nobel) are used as initiator. The mixture is fed into the reactor according to FIG. 2 and is polymerized with the temperature and the residence time as described in Table 1.

TABLE 1

| Exper- | Temper- | | | | | Residence |
|---|---|---|---|---|---|---|
| iment | ature | Educt Composition | | | | Time |
| No. | ° C. | MMA | GMA | Styrene | Initiator | min |
| 1 | 180 | 36.4% | 45.4% | 9.1% | 9.1% | 16.1 |
| 2 | 180 | 37.0% | 46.3% | 9.3% | 7.4% | 16.4 |
| 3 | 181 | 38.9% | 46.3% | 7.4% | 7.4% | 16.4 |
| 4 | 183 | 35.7% | 46.9% | 11.3% | 0.47% | 12 |
| | | | | | TBP EH | |
| | | | | | 5.63% | |
| | | | | | Tx201 | |
| 5 | 183 | 36.7% | 48.3% | 11.6% | 0.48% | 13 |
| | | | | | TBP EH | |
| | | | | | 2.92% | |
| | | | | | Tx201 | |

A conversion into the polymer product in a range of 84 to 91% is resulted, measured by gaschromatic investigation of the monomer residue. The resulted product has an average molecular weight Mn in the range of 2100 bis 5500 g/mol and a dispersion index of 1.65 to 2, see Table 2.

TABLE 2

| Exper- | Conver- | | | | | | |
|---|---|---|---|---|---|---|---|
| iment | sion | Mn | Mw | Dispersion | Conversion % | | |
| No. | % | g/mol | g/mol | Index | MMA | GMA | Styrene |
| 1 | 90 | 2100 | 4300 | 2 | 87.9 | 94.8 | 100 |
| 2 | 90 | 2700 | 5500 | 2 | 88.9 | 95.5 | 100 |
| 3 | 91 | 2700 | 6000 | 2-2.3 | 85-90 | 93 | >99.5 |
| 4 | 84 | 3300 | 7400 | 1.7 | 88 | 91 | 98 |
| 5 | 91 | 5500 | 9200 | 1.65 | 87 | 93 | 98.5 |

What is claimed is:

1. A reactor for carrying out continuous polymerization reactions for the production of polymers with adjustable polymer properties comprising a three-dimensional tubular loop comprising at least 2 tube bends with interposed tube segments, the tube bends having a curving angle of greater than 30°, and the distance between two tube bends being at least three times the tube diameter, the tube bends and the tube segments being arranged in a direction reversed to the curving direction of the tube bends arranging in succession.

2. The reactor according to claim 1 wherein the tube bands of the reactor have a curving angle of greater than 60°.

3. The reactor according to claim 1 wherein the distance between two tube bends is at least 3 times and at most 150 times the tube diameter.

4. The reactor according to claim 3 wherein the distance between two tube bends is at least 10 times and at most 30 times the tube diameter.

5. The reactor according to claim 1 wherein the tube segments has a straight configuration.

6. The reactor according to claim 1 wherein the cross section of the tube bends and the tube segments is substantially circular.

7. The reactor according to claim 1 wherein each of the next tube segment, located between two tube bends, showing a direction largely in opposition to the direction of the previous tube segment.

8. The reactor according to claim 1 wherein each of the next number of at least two tube bends, including interposed tube segments, showing, in their formation, a direction largely in opposition to the direction of the previous number of tube bends.

9. The reactor according to claim 1 wherein the proportion of the tube length to the number of tube bends, multiplied with the tube diameter, is from 3.75 to 60.

10. A process for the continuous production of polymers with adjustable polymer properties using the reactor according to claim 1.

11. The process according to claim 10 wherein the reaction mixture for the production of polymers comprising monomers, additional agents and polymer product is continuously supplied and continuously discharged with a return flow ratio of 5 to 15.

12. The process according to claim 10 wherein setting a flow rate of the reaction mixture resulting in a residence time of the reaction mixture in the reactor of at least 3 minutes.

13. The process according to claim 10 wherein an additional tubular reactor in combination with the reactor according to claim 1 is used.

14. The process according to claim 10 wherein (meth)acrylate copolymers with an average molecular weight Mn of between 1000 and 6000 g/mol and a dispersion index of lower than 2 are produced.

15. The process according to claim 14 wherein a mixture comprising 3 to 60% by weight of glycidyl (meth)acrylate, 0 to 80% by weight of at least non-functionalized (meth)acrylate, and 0 to 80% by weight of at least unsaturated further monomer is used for the production of the (meth)acrylate copolymers, wherein the sum of the monomers adds up to 100% by weight.

16. The process according to claim 14 wherein a mixture comprising 30 to 35% by weight of styrene, 20 to 50% by weight of glycidyl (meth)acrylate and 20 to 45% by weight of methyl (meth)acrylate is used for the production of the (meth)acrylate copolymer, wherein the sum of the monomers adds up to 100% by weight.
